(19) United States
(12) Patent Application Publication
(10) Pub. No.: US 2015/0089826 A1
(43) Pub. Date: Apr. 2, 2015

(54) Measuring Tape

(71) Applicant: Eduardo Villalpando, San Marcos, CA (US)

(72) Inventor: Eduardo Villalpando, San Marcos, CA (US)

(21) Appl. No.: 14/039,299

(22) Filed: Sep. 27, 2013

(51) Int. Cl. G01B 3/10

(52) U.S. Cl. CPC G01B 3/1041; G01B 3/1061; G01B 3/1005; G01B 2003/1007
USPC 33/701; 33/754

(57) ABSTRACT

A tape measure comprising a housing, a retractable measuring tape disposed in the housing, and a measurement base attached to the housing, running parallel to the direction of the tape, a method for employing said tape measure, and a method for reading measurement of said tape measure.

### CROSS-REFERENCE TO RELATED APPLICATIONS

This application is a Continuation-in-Part of U.S. Design Patent application Ser. No. 29/464,316 entitled “Tape Measurer”. The disclosures of these documents are incorporated herein by reference in their entirety.

### STATEMENT REGARDING FEDERALLY SPONSORED RESEARCH OR DEVELOPMENT

Not applicable.

### BACKGROUND OF INVENTION

1. Field of the Invention

The present application relates to the field of tape measures for use in determining measurements.

2. Background of the Invention

A tape measure is generally used to determine the length between two points. For example, prior to installing a broken window pane, a tape measure may be used to measure the dimensions of the opening to ensure a proper fit. Most modern tape measures employ a curved metallic tape that can remain rigid and straight when extended, but can retract into a coil wound within a handheld housing. The tape has markings indicating measurement intervals and has a lip or tang on the protruding end to aid in measuring.

When measuring particular distances, it is important that they are measured accurately by the tape measure. In the aforementioned example, if the measurements are inaccurate, even by a small amount, the window may be too small and cause various sealing issues, or too large and not fit at all. When measuring particular distances, it is also important that they are measured with precision by the tape measure. In the aforementioned example, the tape measure may be used to measure both the opening for the window pane and the potential replacement window pane itself. If precision between measuring the two applications is lost, the installation may go awry and the window will not properly fit in the opening.

Unfortunately, there are many applications where conventional tape measures lose accuracy and precision. For example, accurately measuring the back wall of a microwave is a difficult endeavor using a conventional tape measure. In order to ascertain a measurement, the lip of the tape is placed on one side of the microwave, while the other side proves more problematic. The tape must be bent wherein the bend is placed on the opposite side of the lip. During bending, measurement inaccuracies arise and a once exact measurement turns into a mere estimation. Repeating this bending process in tight spaces and trying to estimate lengths between applications leads to imprecision. Having to bend the tape to ascertain a measurement with a conventional tape measure produces inconsistent and frustrating results.

There have been some notable improvements that have tried to address the problem of inaccuracy and imprecision due to bending of the measuring tape, however, they have not taken the approach of the embodiments of the present application or are inadequate for a variety of reasons. For example, U.S. Pat. No. 0,491,733 (1893) to Foster teaches a ruler combined with a tape measure, but does not solve the inaccuracy issue caused by bending of the tape because the tape extends perpendicular to the direction of the ruler to aid in its essential and specific purpose of measuring animals. U.S. Pat. No. 1,224,592 (1917) to Begany teaches a combination ruler and tape measure, but the exit of the tape from the housing is located on a plane distant from the plane of the ruler and does not provide an adequate means to determine an accurate reading of the extended tape. U.S. Pat. No. 3,885,314 (1975) to Banas teaches a two-way tape measuring device that features two tapes extending from opposite directions from the housing. While the prior teaching allows for measurements posterior to the tape measure housing, it does not provide a means for measuring the distance occupied by the housing, nor does it provide a mechanism for an accurate measurement reading. Moreover, the design is cumbersome and involves the complication of dual coiled tapes.

While each of the improvements is noteworthy, Applicant believes that they fail to adequately address the inaccuracies lost during bending of the tape. Furthermore, Applicant believes that many of the prior art technologies are unlikely to be embraced by users by reason of awkwardness of use, cumbersome designs, overly complicated mechanisms, or expensive retail prices resulting from the overly complicated mechanisms.

### SUMMARY OF THE INVENTION

It is an object of the present application to provide a tape measure that allows the user to quickly and accurately ascertain the exact measurement of a given distance.

It is yet another objective of the present application to provide a tape measure capable of accurate and precise measurements against perpendicular surfaces and in tight spaces by eliminating the necessity to bend the measuring tape. The recited objective may preferably be met by the combination of two key elements. First, a fixed measurement base eliminates the necessity to bend the measuring tape by introducing a flat, posterior edge adjacent to a fixed-length base. Second, an accuracy mechanism allows for a quick, accurate reading of the measuring tape.

Other objectives of the invention will become apparent to those skilled in the art once the invention has been shown and described. These objectives are not to be construed as limitations of applicant's invention, but are merely aimed to suggest some of the many benefits that may be realized by the apparatus of the present application and with its many embodiments.

### BRIEF DESCRIPTION OF THE FIGURES

The manner in which these objectives and other desirable characteristics can be obtained is explained in the following description and attached figures in which:

FIG. 1 is a side view of an embodiment of the tape measure in this application where the inaccuracies caused by the bending of the measuring tape of a typical tape measure have been eliminated through the introduction of the fixed measurement base and the accuracy mechanism.

FIG. 2 is a bottom view of an embodiment of the tape measure in this application focusing on the fixed measurement base.

FIG. 3 is a perspective view of an embodiment of the tape measure in this application demonstrating its use by measuring a particular distance.

FIG. 4 is a dose, overhead view of an embodiment of the tape measure in this application focusing on the accuracy mechanism and its alignment with the tape and fixed measurement base.

FIG. 5 is a perspective view of an embodiment of the tape measure in this application employing a transparent window and measurement marking indicator.

FIG. 6 is a top view of an embodiment of the tape measure in this application focusing on the transparent window and measurement marking indicator.

FIG. 7 is a back view of an embodiment of the tape measure in this application.

### DETAILED DESCRIPTION OF THE INVENTION

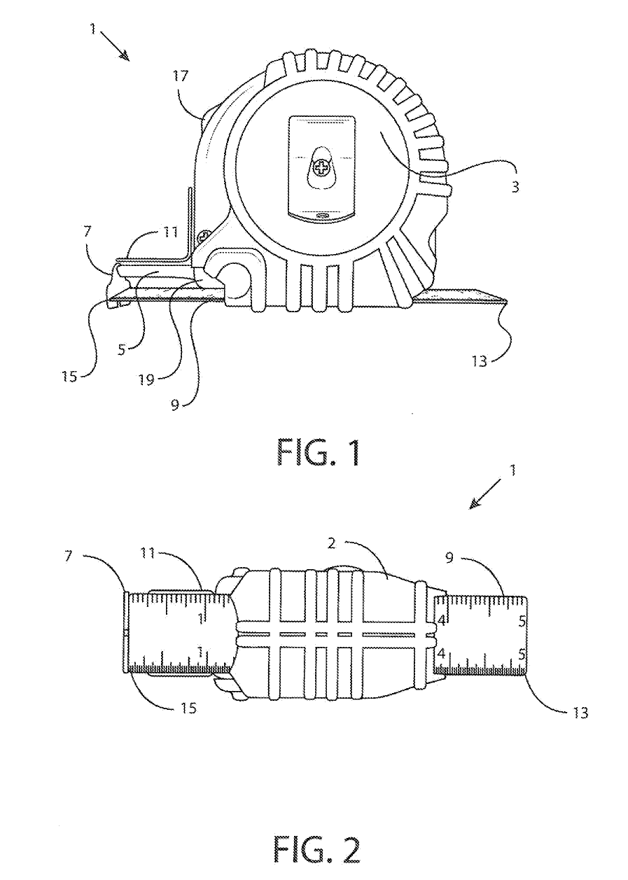

FIG. 1 is a side view of a preferable embodiment of this application where the measurement accuracy of a typical tape measure has been improved through the addition of a fixed measurement base 9 and an accuracy mechanism 11. The tape measure 1 includes a housing 3 which contains a coiled measuring tape 5. The end of the tape 5 protrudes through the housing opening 19 and has a lip 7 rigidly attached to the protruding end. The fixed measurement base 9 is rigidly attached to the bottom of the housing 3 and extends a fixed distance both posterior to, and anterior to, the housing 3. The fixed measurement base 9 runs parallel to the tape 5 and the accuracy mechanism 11. The lip 7 of the tape 5 catches on the anterior end of the fixed measurement base 15 to prevent retrieval difficulty in the event of retraction beyond the end of the accuracy mechanism 11. The accuracy mechanism 11 is preferably rigidly attached to the front of the tape measure 1 above the housing opening 19 and extends away from the housing 3 parallel with the tape 5 and the fixed measurement base 9. The accuracy mechanism 11 and the anterior end of the fixed measurement base 15 extend away from the housing 3 at an equal distance. Additionally there is a lock and retraction switch 17 that controls the locking mechanism and automatic retraction mechanism of the tape 5.

The fixed measurement base 9 improves upon the accuracy and precision of an ordinary tape measure by allowing the user to eliminate the inaccuracies produced through bending the tape 5. Bending the tape 5 is often necessary with an ordinary tape measure when determining a measurement against a wall or in a tight space. For example, measuring the back wall of the inside of a microwave with a standard tape measure would typically require the user to bend the measuring tape in order to ascertain a measurement. Reading a bent measuring tape 5 is an estimation rather than a true measurement and leads to frustrating and inconsistent results. The addition of the fixed measurement base 9 eliminates these difficulties by introducing a flat edge (posterior end of the fixed measurement base 13) where the bending of the tape 5 would typically occur. In the aforementioned microwave example, the improved tape measure in this application would be utilized by placing the posterior end of the fixed measurement base 13 against one wall of the inside of the microwave, while the lip 7 of the tape 5 would rest against the opposite wall of the inside of the microwave. The combination of these two straight edges as the end points, as opposed to estimating the distance on one end where the bent measuring tape would typically be, increases accuracy and precision. Moreover, the accuracy mechanism 11 provides a straight edge on the anterior side of the tape measure 1 to ensure an accurate measurement of the tape 5.

The tape measure in this application further improves upon a standard tape measure by providing a caliper function. Once the two end points, one represented by the posterior end of the fixed measurement base 13 and one represented by the lip 7 of the tape 5, are locked into a particular measurement by the lock and retraction switch 17, the apparatus can be moved to a different application to achieve the exact same measurement length. For example, a user whose application requires cutting two boards of equal length would use the tape measure 1 to accurately measure the first board. The user would then lock the measurement into place using the lock and retraction switch 17, move the apparatus to the next board, and measure the board with the previously measured fixed length, which would result in two boards of the exact same length.

FIG. 2 is a bottom view of the tape measure 1. The fixed measurement base 9 is rigidly attached to the bottom of the tape measure 1 and extends a fixed distance both posterior to, and anterior to, the housing 3. The preferable length of the fixed measurement base 9 is four or five inches, primarily because these two numbers are particularly easy to add to the length of the tape measurement. The fixed measurement base 9 is parallel to the tape (not shown) and the accuracy mechanism 11. The lip 7 of the tape 5 catches on the anterior end of the fixed measurement base 15 to prevent further retraction of the tape into the housing 2.

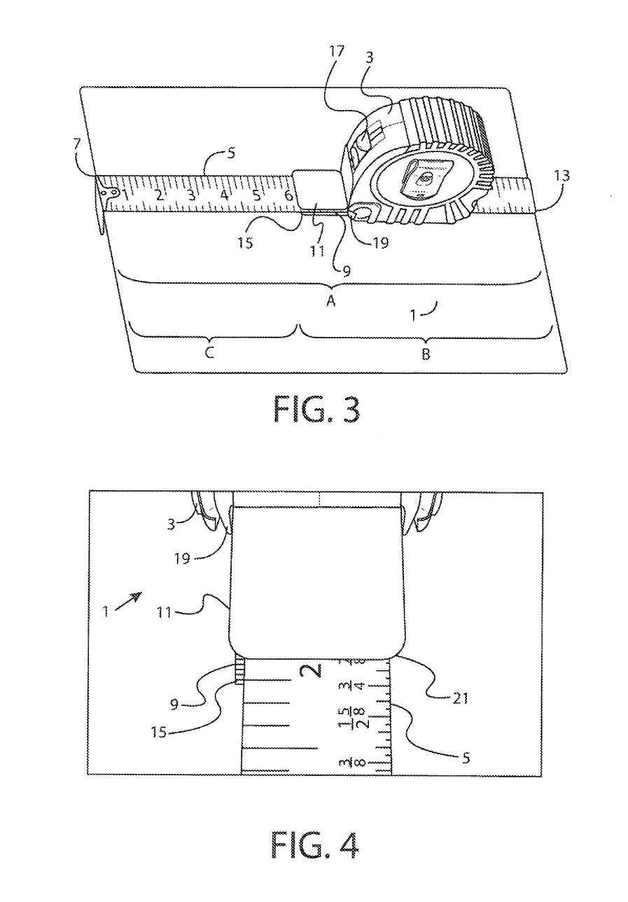

FIG. 3 is a perspective view of the preferable embodiment being utilized to measure a particular distance. The posterior end of the fixed measurement base 13 effectively acts as one end of the total measurement A, and the lip 7 of the tape 5 acts as the other end of the total measurement A. The total measurement A is derived by adding the length of the fixed measurement base B and the length of the tape C. The accuracy mechanism 11 is utilized to ascertain a precise and accurate reading of the length of the tape C, while the length of the fixed measurement base B is fixed and therefore does not fluctuate between measurements. The accuracy mechanism 11 may be composed of, but is not limited to, metal, plastic, or other synthetic materials. An additional embodiment (not shown) of the accuracy mechanism 11 is composed of a clear, synthetic material that acts as a “window” through which the user can view the measurement marks on the tape. A fine red line is preferably added onto, and parallel to, the protruding edge of the accuracy mechanism 11 to further enhance precision and accuracy during reading.

FIG. 4 is a closer, overhead view of the accuracy mechanism 11 where the accuracy mechanism 11 is being utilized to measure the exact measurement on the tape 5. The user can accurately and precisely determine the measurement of the tape 5 using the aid of the accuracy mechanism 11. From this view, the parallel alignment between the accuracy mechanism 11, fixed measurement base 9, and tape 5 can be observed. The accuracy mechanism 11 and the anterior end of the fixed measurement base 15 extend the same distance away from the housing 3 of the tape measure 1. Therefore the user can view the apparatus from overhead, align the protruding end of the accuracy mechanism 21 with the anterior end of the fixed measurement base 15, and determine an exact tape 5 measurement.

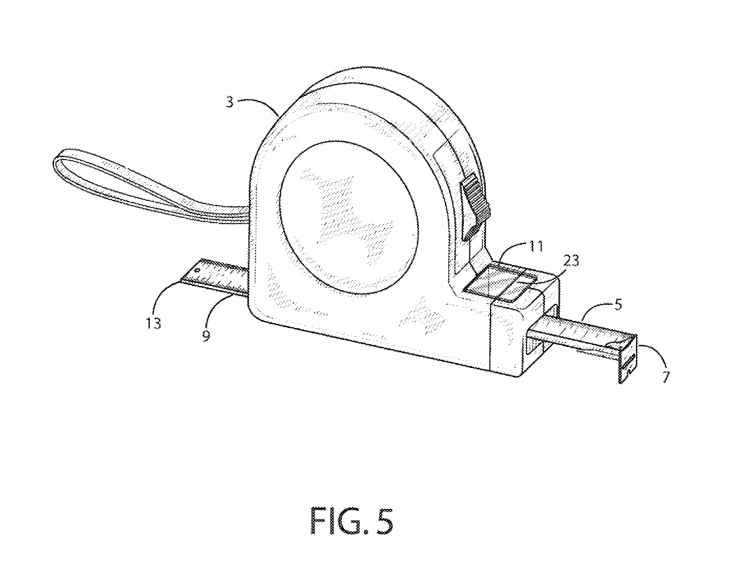

FIG. 5 is a perspective view of an embodiment of the invention similar to the embodiment depicted in FIG. 3. The posterior end 13 of the fixed measurement base 9 effectively acts as one end of the total measurement, and the lip 7 of the tape 5 acts as the other end of the total measurement. The user can accurately and precisely determine the measurement of the tape 5 using the aid of the accuracy mechanism 11. In one embodiment, the posterior end 13 of the fixed measurement base 9 measures five inches from the posterior end of the housing 3. In such an embodiment, the user can determine the total measurement of the measuring tape 5 by reading the measurement via the accuracy mechanism 11 and adding five inches (the length of the fixed measurement base 9). The accuracy mechanism 11 shown in FIG. 5 employs a transparent window with a measurement mark line 23 running through the window in order to read the measurement. In some embodiments, the accuracy mechanism 11 employs a digital viewfinder that automatically adds up the measuring tape measurement and the length of the fixed measurement base and shows the resulting number in a display. The display can be analog or digital and may be placed anywhere on the invention including, but not limited to, the accuracy mechanism, housing, fixed measurement base, or measuring tape.

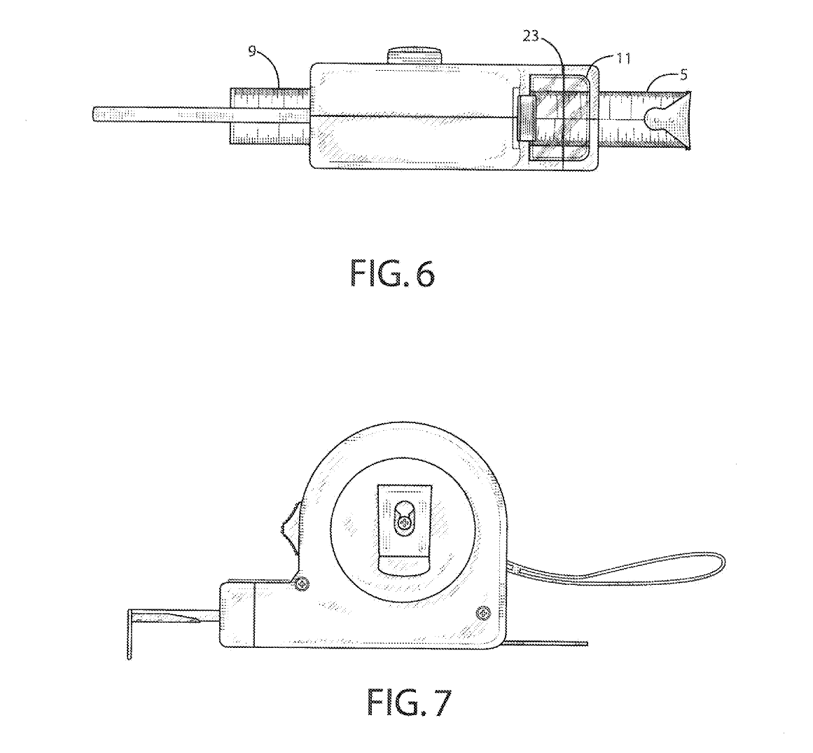

FIGS. 6 and 7 depicts a top and back view, respectively, of the embodiment of the invention shown in FIG. 5. As described in the previous paragraph, the user may read the measurement according to the measurement mark line 23 found in the accuracy mechanism 11 and add the length of the fixed measurement base 9 to get the total measurement. In some embodiments, the length of the fixed measurement base 9 is five inches.

The invention claimed is:

1. A tape measure comprising:
a housing;
a retractable measuring tape disposed in the housing;
a lip attached to the protruding end of the measuring tape; and
a measurement base fixedly attached to the bottom of the housing and running parallel to the direction of the tape.

2. The tape measure of claim 1 wherein the measuring tape is flexible and retractable, having a retracted position coiled within the housing and an extended position protruding out of a tape outlet opening.

3. The tape measure of claim 1 wherein a lock and retraction switch controls a mechanism within the housing that both locks the measuring tape at a fixed distance and releases it causing an automatic retraction of the measuring tape into a coiled position within the housing.

4. The tape measure of claim 1 wherein the fixed measurement base extends posterior to the housing of the tape measure.

5. The tape measure of claim 4 wherein the fixed measurement base extends five inches posterior to the housing of the tape measure.

6. The tape measure of claim 1 wherein the fixed measurement base extends anterior to the housing of the tape measure.

7. The tape measure of claim 6 wherein the fixed measurement base extends posterior to the housing of the tape measure.

8. The tape measure of claim 1 wherein an accuracy mechanism for ascertaining an accurate reading of the measurement of the measuring tape is attached to the front of the housing running parallel to the direction of the tape.

9. The tape measure of claim 8 wherein the anterior edge of the accuracy mechanism extends anteriorly an equal distance as the anterior edge of the fixed measurement base.

10. The tape measure of claim 8 w herein the accuracy mechanism is attached above the tape outlet opening.

11. The tape measure of claim 8 wherein the accuracy mechanism is transparent and includes a measurement indicator on its anterior edge.

12. The tape measure of claim 8 wherein the accuracy mechanism is electronic and indicates the measurement via a display.

13. A method for measuring a fixed distance between two points, comprising the steps of:
identifying a first point of a fixed distance to be measured;
placing a lip of a measuring tape from a tape measure on the first point of the fixed distance to be measured;
extending the lip of the measuring tape from the tape measure;
identifying a second point of the fixed distance to be measured;
placing the posterior edge of a fixed measurement base attached to the tape measure on the second point of the fixed distance to be measured;
reading a measurement indicator mark on the measuring tape; and
adding the length of the fixed measurement base to the tape measurement ascertained from reading the indicator mark on the measuring tape.

14. The method of claim 13 wherein the length of the fixed measurement base is 5 inches.

15. The method of claim 13 wherein an accuracy mechanism is employed to aid the user in ascertaining an accurate reading of the measurement indicator mark on the measuring tape.

16. The method of claim 15 wherein the accuracy mechanism is a transparent viewfinder.

17. The method of claim 15 wherein the accuracy mechanism is an electronic viewfinder with a display.

18. The method of claim 15 wherein the anterior edge of the accuracy mechanism and anterior edge of the fixed measurement base are linearly aligned, creating a single line viewable from overhead to read the correct indicator mark on the measuring tape.

19. The method of claim 15 wherein a lock and retraction switch locks measuring tape at a desired fixed length.

20. The method of claim 19 wherein the tape measure locked at a fixed length is moved to a second application and used to indicate the exact same length as measured in the first application.
